(19) United States
(12) Patent Application Publication
(10) Pub. No.: US 2026/0328354 A1
(43) Pub. Date: Oct. 22, 2026

(54) VEHICLE HEADLAMP

(71) Applicant: KOITO MANUFACTURING CO., LTD., Tokyo (JP)

(72) Inventors: Takaya SHIMIZU, Shizuoka-shi, Shizuoka (JP); Takahiko HONDA, Shizuoka-shi, Shizuoka (JP); Ryosuke FUKUI, Shizuoka-shi, Shizuoka (JP); Yuta TSUYUKI, Shizuoka-shi, Shizuoka (JP)

(73) Assignee: KOITO MANUFACTURING CO., LTD., Tokyo (JP)

(21) Appl. No.: 18/880,966

(22) PCT Filed: Aug. 21, 2023
(86) PCT No.: PCT/JP2023/029974

§ 371 Date: Jan. 3, 2025

(30) Foreign Application Priority Data
Aug. 22, 2022 (JP) 2022-131962
Aug. 26, 2022 (JP) 2022-135098

(51) Int. Cl. F21S 41/26; F21S 41/148; F21S 41/32; F21S 41/43; F21S 41/65; F21W 102/135; F21W 102/19

(52) U.S. Cl. CPC F21S 41/26; F21S 41/148; F21S 41/321; F21S 41/43; F21S 41/65; F21W 2102/135; F21W 2102/19

(57) ABSTRACT

A vehicle headlamp (1) includes a first light source (30L), (30H) that emits light to be one of a low beam and a high beam, a second light source (30S), and a projection lens (60) that projects the light from the first light source (30L), (30H) to a front of a vehicle and projects light from the second light source (30S) to a side of the vehicle, and in the projection lens (60), a part of an area through which the light from the second light source (30S) propagates is used also as an area through which the light from the first light source (30L), (30H) propagates.

### TECHNICAL FIELD

The present invention relates to a vehicle headlamp.

### BACKGROUND ART

A known vehicle headlamp includes a headlamp that emits light to be a low beam to the front of a vehicle and a cornering lamp that emits light to each of the left and right sides of a vehicle. Patent Literature 1 described below discloses such a vehicle headlamp. In the vehicle headlamp, the cornering lamp is lit with illuminance lower than specified illuminance. By lighting such a cornering lamp, the visibility of sides is ensured, and the power consumption is reduced as compared with the case where the cornering lamp is lit at the specified illuminance that is the original illuminance.

Another known vehicle headlamp includes: a lamp unit for a low beam that emits light of a low-beam light distribution pattern to the front of a vehicle; and an auxiliary lamp unit that emits light of another light distribution pattern projected to the neighborhood of the low-beam light distribution pattern in the left-right direction. Patent Literature 2 described below discloses such a vehicle headlamp. In the vehicle headlamp, a horizontally long light distribution pattern including a low-beam light distribution pattern and another light distribution pattern is projected to the front of a vehicle, a traveling road in front of a vehicle is widely irradiated, and visibility is improved.
[Patent Literature 1] JP 2014-4882 A
[Patent Literature 2] JP 2005-141919 A

### SUMMARY OF INVENTION

A vehicle headlamp of a first aspect of the present invention includes a first light source that emits light to be one of a low beam and a high beam, a second light source, and a projection lens that projects the light from the first light source to a front of a vehicle and projects light from the second light source to a side of the vehicle, and in the projection lens, a part of an area through which the light from the second light source propagates is used also as an area through which the light from the first light source propagates.

In the vehicle headlamp of the first aspect, a part of the area in the projection lens, through which the light from the second light source propagates, is used also as a part of the area through which the light from the first light source propagates. Accordingly, in the projection lens, the area through which the light from the second light source propagates is not used also as the area through which the light from the first light source propagates, and the projection lens can be downsized as compared with a case where these areas are located apart from each other. Therefore, with this configuration, the vehicle headlamp can be downsized.

In the vehicle headlamp of the first aspect, at least a part of the light from the second light source may be emitted from an emission area of the projection lens, from which the light from the first light source is emitted.

With this configuration, the projection lens can be downsized as compared with a case where both the emission area from which the light from the first light source is emitted and the emission area from which the light from the second light source is emitted are located apart from each other in the projection lens. Therefore, with this configuration, the vehicle headlamp can be downsized.

A vehicle headlamp of the first aspect of the present invention includes a first light source that emits light to be one of a low beam and a high beam, a second light source, and a projection lens that projects the light from the first light source to a front of a vehicle and projects light from the second light source to a side of the vehicle, and at least a part of the light from the second light source is emitted from an emission area of the projection lens, from which the light from the first light source is emitted.

In the vehicle headlamp of the first aspect, at least a part of the light from the second light source is emitted from an emission area of the projection lens, from which the light from the first light source is emitted. Accordingly, the projection lens can be downsized as compared with a case where both the emission area from which the light from the first light source is emitted and the emission area from which the light from the second light source is emitted are located apart from each other in the projection lens. Therefore, with this configuration, the vehicle headlamp can be downsized.

In the vehicle headlamp of the first aspect, the light from the second light source may travel directly from an incident area of the projection lens on which the light from the second light source is incident to the emission area of the projection lens.

As compared with a case where the light from the second light source travels from the incident area of the projection lens to the emission area of the projection lens by being reflected inside the projection lens, this configuration can reduce loss of light, such as leakage of a part of light to the outside of the projection lens when light is reflected inside the projection lens.

In the vehicle headlamp of the first aspect, the emission area may include a first area that emits the light from the first light source, and a second area that is located adjacent to the first area and emits the light from the first light source and the light from the second light source.

In the vehicle headlamp of the first aspect, at least a part of an incident area of the projection lens on which the light from the second light source is incident may not overlap an incident area of the projection lens, on which the light from the first light source is incident.

In the vehicle headlamp of the first aspect, the first light source may comprise two first light sources, one first light source of the two first light sources may emit light of a low beam, the other first light source of the two first light sources may emits light of a high beam, and the light from the second light source may be emitted from the emission area from which the light from the first light source provided on an outer side of the vehicle among the one first light source and the other first light source is emitted.

In the vehicle headlamp of the first aspect, in the projection lens, a part of an area through which the light from the second light source propagates may be used also as an area through which the light from the first light source propagates.

With these configurations, in the projection lens, the area through which the light from the second light source propagates is not used also as the area through which the light from the first light source propagates, and the projection lens can be downsized as compared with a case where these areas are located apart from each other. Therefore, with these configurations, the vehicle headlamp of the first aspect can be downsized.

As described above, the first aspect of the present invention can provide a vehicle headlamp that can be downsized.

A vehicle headlamp of a second aspect of the present invention includes a lamp unit of a projector ellipsoid system (PES) type, the lamp unit including a first light source that emits first light to be one of light of a low-beam light distribution pattern or light of an additional light distribution pattern that is added to the low-beam light distribution pattern to form a high-beam light distribution pattern, a reflector that covers the first light source and reflects at least a part of the first light from the first light source, and a projection lens that projects the first light reflected by the reflector to a front of a vehicle, and a second light source that emits second light of another light distribution pattern reflected by the reflector and projected to a front of the vehicle and to a neighborhood of a light distribution pattern of the first light by the projection lens, and the second light source is mounted at a position covered by the reflector in the lamp unit.

In the vehicle headlamp of the second aspect, the first light source and the second light source are mounted at positions covered by the reflector in the same PES-type lamp unit. Accordingly, as compared with a case where the lamp unit on which the first light source is mounted and the lamp unit on which the second light source is mounted are provided separately, the vehicle headlamp can be downsized while being capable of projecting, to the front of a vehicle, a horizontally long light distribution pattern including a light distribution pattern of the light from the first light source and another light distribution pattern of the light from a second light source, which is different from the light distribution pattern.

In the vehicle headlamp of the second aspect, the lamp unit may further include a shade that is provided between the reflector and the projection lens and blocks a part of each of the first light and the second light forming the low-beam light distribution pattern reflected by the reflector.

In this configuration, the cutoff line of a low-beam light distribution pattern is formed by the shade. Moreover, in this configuration, the second light from the second light source is reflected by the reflector, a part of the second light reflected by the reflector is blocked by the shade, and the other part of the second light is projected to the front of a vehicle by the projection lens without being blocked by the shade. With this configuration, the light distribution pattern of the second light is prevented from being projected above the cutoff line of the low-beam light distribution pattern. Therefore, a driver of a vehicle can be prevented from having a feeling of strangeness due to the light distribution pattern of the second light being projected above the cutoff line when the low-beam light distribution pattern is projected.

In the vehicle headlamp of the second aspect, the second light source may be provided adjacent to the first light source in a left-right direction of the vehicle and at a height position identical to a height position of the first light source.

Alternatively, in the vehicle headlamp of the second aspect, the second light source may be provided adjacent to the first light source in the left-right direction of the vehicle and at a position below the first light source.

In the vehicle headlamp of the second aspect, the lamp unit may further include a shade that is provided between the reflector and the projection lens and blocks a part of the first light forming the low-beam light distribution pattern reflected by the reflector, and the other part of the first light and the second light that are reflected by the reflector may be projected to a front of the vehicle by the projection lens without being blocked by the shade.

In these configurations as well, the cutoff line of the low-beam light distribution pattern is formed by the shade. Furthermore, in these configurations, the second light from the second light source is reflected by the reflector, the second light reflected by the reflector is projected to the front of a vehicle by the projection lens without being blocked by the shade. With this configuration, as compared with a case where the second light is blocked by the shade, the second light is not blocked by the shade, and thus the front of a vehicle can be irradiated without waste, and deterioration of the shade due to irradiation of the second light can be prevented.

In the vehicle headlamp of the second aspect, the second light source may be provided adjacent to the first light source in the left-right direction of the vehicle and at a position below the first light source.

Alternatively, in the vehicle headlamp of the second aspect, the second light source may be provided at a position further on a rear side with respect to the first light source.

In the vehicle headlamp of the second aspect, the first light may be light forming the additional light distribution pattern, and when the first light source does not emit the first light and a front of the vehicle is irradiated with the first light of the low-beam light distribution pattern, the light distribution pattern of the second light from the second light source may be projected to a neighborhood of an area in front of the vehicle based on an assumption that the additional light distribution pattern is projected to a front of the vehicle, and the low-beam light distribution pattern.

In the vehicle headlamp of the second aspect, the first light may be light forming the additional light distribution pattern, and when the first light source emits the first light and a front of the vehicle is irradiated with the first light of the low-beam light distribution pattern, the light distribution pattern of the second light from the second light source may be projected to a neighborhood of the additional light distribution pattern and the low-beam light distribution pattern.

In the vehicle headlamp of the second aspect, the lamp unit may further include a first light source that emits first light to be light of the low-beam light distribution pattern and the other of light of the additional light distribution pattern, the first light source being mounted at a position covered by the reflector.

As described above, the second aspect of the present invention can provide a vehicle headlamp that can be downsized while being capable of projecting, to the front of a vehicle, a horizontally long light distribution pattern including a certain light distribution pattern and another light distribution pattern different from this light distribution pattern.

### BRIEF DESCRIPTION OF DRAWINGS

FIG. 1 is a schematic view of a vehicle headlamp according to a first embodiment as a first aspect of the present invention.

FIG. 2 is a sectional view schematically illustrating a lamp unit for a low beam.

FIG. 3 is a sectional view schematically illustrating a lamp unit for a high beam.

FIG. 4 is a schematic view of the vehicle headlamp in a modification.

FIG. 5 is a schematic view of a vehicle headlamp according to a second embodiment as a second aspect of the present invention.

FIG. 6 is a sectional view schematically illustrating a lamp unit for a low beam.

FIG. 7 is a diagram illustrating a low-beam light distribution pattern and an enlarged light distribution pattern.

FIG. 8 is a diagram illustrating a high-beam light distribution pattern and the enlarged light distribution pattern.

FIG. 9 is a view illustrating a first modification of the position of a second light source.

FIG. 10 is a view illustrating a second modification of the position of the second light source.

FIG. 11 illustrates a third modification of the position of the second light source, and is a top view of a first light source and the second light source and the periphery thereof in the third modification.

FIG. 12 is a view illustrating a manner of traveling of each of first light and second light in the third modification.

FIG. 13 is a diagram illustrating the low-beam light distribution pattern and the enlarged light distribution pattern according to the third modification.

FIG. 14 illustrates a fourth modification of the position of the second light source, and is a top view of the first light source and the second light source and the periphery thereof in the fourth modification.

FIG. 15 is a view illustrating a manner of traveling of each of the first light and the second light in the fourth modification.

FIG. 16 is a diagram illustrating the low-beam light distribution pattern and the enlarged light distribution pattern according to the fourth modification.

FIG. 17 is a diagram illustrating the high-beam light distribution pattern and the enlarged light distribution pattern according to the fourth modification.

FIG. 18 illustrates a fifth modification of the positions of the first light source and the second light source, and is a top view of the first light source and the second light source and the periphery thereof in the fifth modification.

### DESCRIPTION OF EMBODIMENTS

Hereinafter, embodiments for implementing a vehicle headlamp according to the present invention will be illustrated together with the accompanying drawings. The embodiments illustrated below are intended to facilitate understanding of the present invention and are not intended for a limited interpretation of the present invention. The present invention can be modified and improved without departing from the spirit thereof. Note that the drawings referred to below may illustrate each member by changing dimensions thereof for facilitating understanding. In the drawings, for the sake of ensuring viewability, only some of similar components are denoted by reference signs, and some reference signs may be omitted.

### First Embodiment

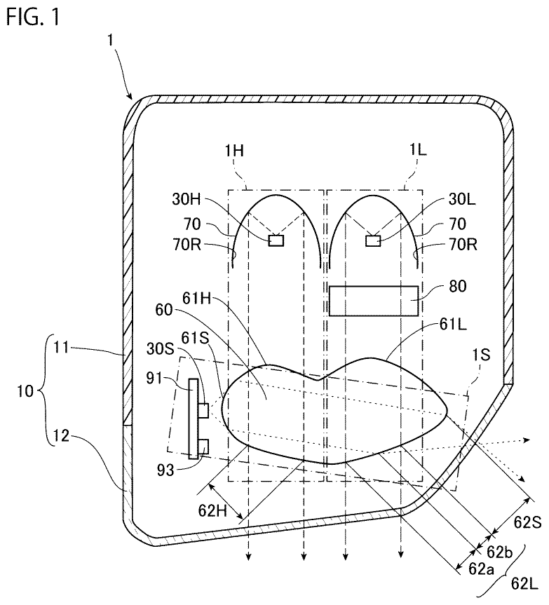

A first embodiment as a first aspect of the present invention will be described. FIG. 1 is a schematic view of a vehicle headlamp according to the present embodiment. Such a vehicle headlamp 1 is generally provided in each of the left-right directions on the front side of a vehicle, and the left and right vehicle headlamps 1 have a substantially symmetrical configuration in the left-right direction. Therefore, in the present embodiment, the vehicle headlamp 1 on the left side will be described. Note that, in the present specification, “right” means the right side in the forward direction of a vehicle, and “left” means the left side in the forward direction. The vehicle in the present embodiment is an automobile.

The vehicle headlamp 1 includes a housing case 10, a lamp unit 1L for a low beam, a lamp unit 1H for a high beam, and a side lamp unit 1S that emits light to the left side of a vehicle. In the present embodiment, the lamp unit 1L is located on the outer side of a vehicle with respect to the lamp unit 1H, and is aligned with the lamp unit 1H in the left-right direction. The side lamp unit 1S is a side irradiation lamp, a so-called cornering lamp.

The housing case 10 includes a housing 11 and a front cover 12. The housing 11 is formed in a box shape having an opening on the front side, and the front cover 12 is fixed to the housing 11 so as to close the opening. In this way, a housing space surrounded by the housing 11 and the front cover 12 is formed in the housing case 10, and the lamp units 1L, 1H, and 1S are disposed in the housing space. The front cover 12 transmits light emitted from the lamp units 1L, 1H, and 1S.

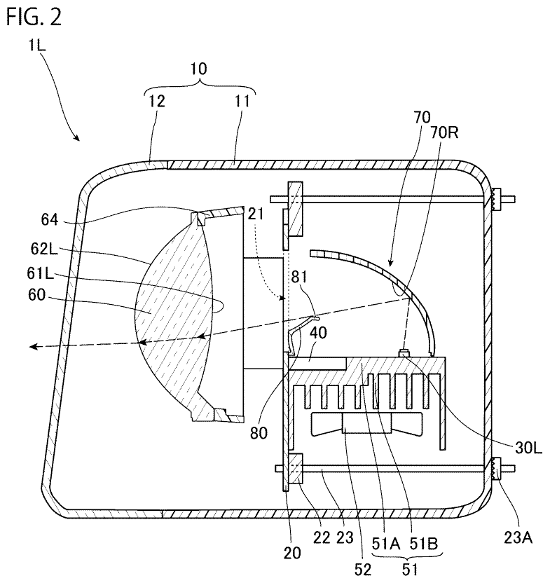

FIG. 2 is a sectional view schematically illustrating the lamp unit 1L. The lamp unit 1L includes a base plate 20, a first light source 30L, a light control circuit 40, a heat sink 51, a cooling fan 52, a projection lens 60, a reflector 70, and a shade 80.

The base plate 20 is a metal plate-shaped member extending substantially in the vertical direction and is fixed to the housing 11 of the housing case 10. The base plate 20 includes an opening 21 extending through the base plate 20 in the front-rear direction, and the opening 21 is located on the optical path of light emitted from the first light source 30L.

A bracket 22 is coupled to the base plate 20. One end of a plurality of optical axis adjusting screws 23 are screwed to the bracket 22, and the optical axis adjusting screws 23 are supported by the housing 11. A head 23A serving as the other end of the optical axis adjusting screw 23 is exposed to the outside of the housing space of the housing case 10. The bracket 22 is screwed and tilted by rotating the head 23A, and the optical axis can be adjusted in the up-down and left-right directions.

The first light source 30L in the lamp unit 1L emits light to be a low beam. The first light source 30L includes, for example, a light emitting diode (LED). Switching ON and OFF of the power supply for the first light source 30L, intensity of light from the first light source 30L, and the like are controlled by the light control circuit 40. The light control circuit 40 and the first light source 30L are fixed to a base board 51A of the heat sink 51 described later.

The heat sink 51 includes the metal base board 51A extending substantially in the horizontal direction, and the first light source 30L and the light control circuit 40 are fixed to one surface side of the base board 51A. In addition, a plurality of heat dissipation fins 51B is integrally provided on a surface of the base board 51A opposite to a side where the first light source 30L and the light control circuit 40 are provided. Among the plurality of heat dissipation fins 51B, the heat dissipation fin 51B located at the foremost position is fixed to the back surface of the base plate 20. The cooling fan 52 is disposed with a gap interposed between the cooling fan 52 and the heat dissipation fin 51B and is fixed to the heat sink 51. The heat generated by the first light source 30L and the light control circuit 40 is transmitted from the base board 51A to the heat dissipation fin 51B, and the heat dissipation fin 51B is cooled by the airflow caused by the rotation of the cooling fan 52. Therefore, the heat of the first light source 30L and the light control circuit 40 is efficiently diffused.

The reflector 70 includes a curved plate material and is fixed to the base board 51A of the heat sink 51 so as to cover the first light source 30L. The surface of the reflector 70 opposing the first light source 30L is a reflective surface 70R that reflects light from the first light source 30L without transmitting the light. The reflective surface 70R is based on an ellipsoidal curved surface, and the first light source 30L is disposed at or near a position of a first focal point of the ellipsoidal curved surface. At least a part of light emitted from the first light source 30L is reflected by the reflective surface 70R toward the projection lens 60 through the opening 21, is transmitted through the projection lens 60, and is emitted.

The projection lens 60 is a convex lens, is disposed in front of the base plate 20, and is fixed to the base plate 20 with a lens holder 64 interposed therebetween. The projection lens 60 includes: an incident area 61L on which light from the first light source 30L is incident; and an emission area 62L from which light from the first light source 30L incident on the projection lens 60 from the incident area 61L is emitted forward. The incident area 61L is convexly curved rearward and opposes the emission area 62L. The emission area 62L is convexly curved forward. In the present embodiment, the projection lens 60 is disposed such that the rear focal point of the projection lens 60 is located at or near the second focal point of the reflective surface of the reflector 70. That is, in the lamp unit 1L of the present embodiment, a projector ellipsoid system (PES) optical system is adopted.

The shade 80 is disposed between the first light source 30L and the projection lens 60 and is fixed to the base plate 20. An edge portion 81, which is an upper end portion of the shade 80, is located at or near the second focal point of the ellipsoidal curved surface of the reflective surface 70R. The shade 80 is irradiated with a part of light emitted from the first light source 30L and reflected by the reflector 70. The shade 80 blocks a part of light from the first light source 30L such that a light distribution pattern of light emitted from the emission area 62L of the projection lens 60 matches a low-beam light distribution pattern. Therefore, a part of light is blocked by the shade 80 and is not incident on the projection lens 60. The other part of light travels directly from the reflective surface 70R to the incident area 61L of the projection lens 60 without being blocked by the shade 80. This light is incident on the incident area 61L or is reflected by the edge portion 81 of the shade 80, and is incident on the incident area 61L. In this way, light of a low-beam light distribution pattern reflecting the shape of the cutline by the edge portion 81 of the shade 80 is emitted from the emission area 62L of the projection lens 60.

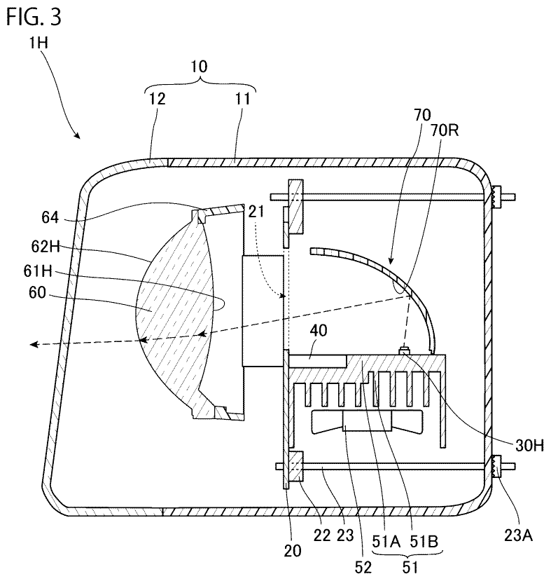

FIG. 3 is a sectional view schematically illustrating the lamp unit 1H. The lamp unit 1H has the same configuration as the lamp unit 1L except that the shade 80 is omitted from the configuration of the lamp unit 1L and a first light source 30H is provided instead of the first light source 30L.

The first light source 30H in the lamp unit 1H emits light to be a high beam. The first light source 30H includes, for example, an LED. Switching ON and OFF of the power supply for the first light source 30H, intensity of light from the first light source 30H, and the like are controlled by the light control circuit 40 of the lamp unit 1H, similarly to the lamp unit 1L. In the heat sink 51 and the cooling fan 52 of the lamp unit 1H, similarly to the lamp unit 1L, the heat of the first light source 30H and the light control circuit 40 of the lamp unit 1H is efficiently diffused.

A surface of the reflector 70 in the lamp unit 1H, opposing the first light source 30H, is the reflective surface 70R that reflects light from the first light source 30H without transmitting the light. The reflective surface 70R is based on an ellipsoidal curved surface, and the first light source 30H is disposed at or near a position of a first focal point of the ellipsoidal curved surface. At least a part of light emitted from the first light source 30H is reflected by the reflective surface 70R of the lamp unit 1H toward the projection lens 60 through the opening 21, is transmitted through the projection lens 60, and is emitted.

In FIG. 3, the emission area and the incident area of the projection lens 60 of the lamp unit 1H are illustrated as an incident area 61H and an emission area 62H. Light from the first light source 30H is incident on the incident area 61H via the reflective surface 70R, and the incident area 61H is convexly curved rearward. The emission area 62H emits light from the first light source 30H incident on the projection lens 60 from the incident area 61H forward, opposes the incident area 61H, and is curved convexly forward. In the present embodiment, the projection lens 60 is disposed such that the rear focal point of the projection lens 60 is located at or near the second focal point of the reflective surface of the reflector 70. That is, the PES optical system is adopted also in the lamp unit 1H of the present embodiment.

At least a part of light emitted from the first light source 30H is reflected by the reflector 70 and is incident on the incident area 61L of the projection lens 60. Accordingly, light of a high-beam light distribution pattern is emitted from the emission area 62L of the projection lens 60.

As illustrated in FIG. 1, the projection lens 60 in the lamp units 1L and 1H is one lens that is horizontally long in the left-right direction. A part of the horizontally long projection lens 60 is a projection lens for a low beam, and another part of the projection lens 60 adjacent to the part of the projection lens 60 is a projection lens for a high beam. Therefore, it can be understood that the projection lens 60 in each of the lamp units 1L and 1H is integrated. The projection lens 60 described above projects light from the first light sources 30L and 30H to the front of a vehicle.

The incident area 61L and the incident area 61H do not overlap each other on the rear surface of projection lens 60. Also, the emission area 62L and the emission area 62H do not overlap each other on the front surface of projection lens 60. In the present embodiment, the incident area 61H is located on the inner side of a vehicle with respect to the incident area 61L, and the emission area 62H is located on the inner side of a vehicle with respect to the emission area 62L.

The lamp unit 1S includes a base plate 91, a second light source 30S, a light control circuit 93, and the projection lens 60.

The base plate 91 is a metal plate-shaped member extending substantially in the vertical direction and is fixed to the housing 11 of the housing case 10. Similarly to the base plate 20 and the bracket 22, a bracket (not illustrated) is coupled to the base plate 91. The optical axis can be adjusted in the up-down and left-right directions by rotating the head (not illustrated) of the bracket.

The second light source 30S emits light for a cornering lamp. The second light source 30S includes, for example, an LED. Switching ON and OFF of the power supply for the second light source 30S, intensity of light from the second light source 30S, and the like are controlled by the light control circuit 93 of the lamp unit 1S, similarly to the lamp unit 1L. The light control circuit 93 and the second light source 30S are fixed to the base plate 91.

Note that a heat sink and a cooling fan having the same configuration as the heat sink 51 and the cooling fan 52 may be provided on a surface of the base plate 91 opposite to the surface to which the second light source 30S is fixed. The heat generated by the second light source 30S and the light control circuit 93 is transmitted from the base plate 91 to the heat dissipation fin via the base board of the heat sink. In addition, the heat dissipation fin of the heat sink is cooled by the airflow caused by the rotation of the cooling fan. Therefore, the heat of the second light source 30S and the light control circuit 93 is efficiently diffused.

The second light source 30S, the light control circuit 93, and the base plate 91 are provided on the right side of the projection lens 60.

The projection lens 60 in the lamp unit 1S is the projection lens 60 in the lamp unit 1L and the lamp unit 1H. Therefore, one projection lens 60 is shared among the lamp unit 1L, the lamp unit 1H, and the lamp unit 1S, and is a lens common to these units.

The projection lens 60 further includes an incident area 61S on which light from the second light source 30S is incident and which is convexly curved rightward. In the present embodiment, the incident area 61S is provided on the right side surface of the projection lens 60. Therefore, the incident area 61S does not overlap the incident areas 61L and 61H and the emission areas 62L and 62H, and light from the second light source 30S is incident on the projection lens 60 from a position deviated from the position of the projection lens 60, on which light from the first light sources 30L and 30H is incident.

The projection lens 60 emits light from the second light source 30S to the side of a vehicle from the emission area 62L. That is, light from the second light source 30S is emitted from the emission area 62L of the projection lens 60, from which light from the first light source 30L is emitted. It is sufficient that at least a part of light from the second light source 30S be emitted from the emission area 62L. Light from the second light source 30S travels directly from the incident area 61S of the projection lens 60 to the emission area 62L thereof without being reflected inside the projection lens 60. The emission area 62L of the present embodiment includes: a first area 62a that emits light from the first light source 30L; and a second area 62b that is located adjacent to the first area 62a and emits light from the first light source 30L and light from the second light source 30S. The second area 62b is located outside a vehicle with respect to the first area 62a. The second area 62b is smaller than the first area 62a, but may be larger than or equal to the first area 62a. The second area 62b opposes the incident area 61S.

The projection lens 60 further includes an emission area 62S that is provided on the left side surface of the projection lens 60 and from which only light from the second light source 30S is emitted to the left side. Therefore, the projection lens 60 of the present embodiment projects light from the second light source 30S leftward from the emission areas 62L and 62S. The emission area 62S is convexly curved leftward. The emission area 62S is located adjacent to the second area 62b. Specifically, the emission area 62S is located opposite the first area 62a with reference to the second area 62b and is connected to the second area 62b. Therefore, light from the second light source 30S is further emitted from the side emission area 62S located adjacent to the emission area 62L. The emission area 62S is smaller than the emission area 62L and larger than the second area 62b. The relationship between the sizes of the emission area 62S and the emission area 62L and the relationship between the sizes of the emission area 62S and the second area 62b are not particularly limited. The emission area 62S opposes the incident area 61S.

Next, the operation of the vehicle headlamp 1 of the present embodiment will be described.

As illustrated in FIGS. 1 and 2, in the lamp unit 1L in the state of emitting a low beam, light is emitted from the first light source 30L for a low beam, and this light is mainly reflected by the reflective surface 70R of the reflector 70. A part of light reflected by the reflective surface 70R is blocked by the shade 80, and the other part thereof is incident from the incident area 61L of the projection lens 60 and emitted from the emission area 62L thereof. Accordingly, light having a low-beam light distribution pattern is emitted forward from the vehicle headlamp 1.

As illustrated in FIGS. 1 and 3, in the lamp unit 1H in the state of emitting a high beam, light is emitted from the first light source 30H for a high beam, and the light is mainly reflected by the reflective surface 70R of the reflector 70. Light reflected by the reflective surface 70R is incident from the incident area 61H of the projection lens 60 and is emitted from the emission area 62H thereof. Accordingly, light having a high-beam light distribution pattern is emitted forward from the vehicle headlamp 1.

As illustrated in FIG. 1, in the lamp unit 1S in a state where the lamp unit 1S is lit, light is emitted from the second light source 30S. The light is incident from the incident area 61S of the projection lens 60, and travels directly from the incident area 61S to the emission area 62L without being reflected inside the projection lens 60. Then, light is emitted from the second area 62b of the emission area 62L. As described above, light from the second light source 30S is emitted from the emission area 62L from which light from the first light source 30L provided on the outer side of a vehicle among the first light source 30L and the first light source 30H is emitted. Light from the second light source 30S is incident from the incident area 61S, travels directly from the incident area 61S to the emission area 62S without being reflected inside the projection lens 60, and is further emitted from the emission area 62S. In this manner, light from the second light source 30S is incident on the projection lens 60 from the right side surface of the projection lens 60, and is emitted leftward from the front surface and the left side surface of the projection lens 60. Accordingly, light is emitted laterally from the vehicle headlamp 1. Note that light does not travel from the incident area 61S to the emission area 62H of the lamp unit 1H and is not emitted from the emission area 62H. In addition, in the projection lens 60, a part of the area through which light from the second light source 30S propagates is used also as the area through which light from the first light source 30H propagates, and another part of the area is used also as the area through which light from the first light source 30L propagates. Therefore, in the projection lens 60, the optical path of light from the second light source 30S intersects with the optical path of light from the first light source 30H and the optical path of light from the first light source 30L.

In the vehicle headlamp of Patent Literature 1 described above, the headlamp and the cornering lamp are provided separately. Since the projection lens is individually provided in each of the headlamp and the cornering lamp, the vehicle headlamp tends to be upsized as a whole. Therefore, downsizing of a vehicle headlamp is required.

Given this circumstance, in the vehicle headlamp 1 of the present embodiment, a part of the area in the projection lens 60, through which light from the second light source 30S propagates, is used also as the area through which light from the first light source 30L or 30H propagates.

With this configuration, in the projection lens 60, the area through which light from the second light source 30S propagates is not used also as the area through which light from the first light source 30L or 30H propagates, and the projection lens 60 can be downsized as compared with a case where these areas are located apart from each other. Therefore, with this configuration, the vehicle headlamp 1 can be downsized.

In the vehicle headlamp 1 of the present embodiment, at least a part of light from the second light source 30S is emitted from the emission area 62L of the projection lens 60 from which light from the first light source 30L is emitted.

With this configuration, the projection lens 60 can be downsized as compared with a case where both the emission area 62L from which light from the first light source 30L is emitted and the emission area from which light from the second light source 30S is emitted are located apart from each other in the projection lens 60. Therefore, with this configuration, the vehicle headlamp 1 can be downsized.

Light from the second light source 30S travels directly from the incident area 61S of the projection lens 60, on which light from the second light source 30S is incident, to the emission area 62L thereof.

As compared with a case where light from the second light source 30S is reflected inside the projection lens 60 from the incident area 61S of the projection lens 60 and travels to the emission area 62L thereof, this configuration can reduce loss of light, such as leakage of a part of light to the outside of the projection lens 60 when light is reflected inside the projection lens 60. Note that light from the second light source 30S may travel from the incident area 61S to the emission area 62L by being reflected inside the projection lens 60.

In addition, light from the second light source 30S is further emitted from the emission area 62S for side irradiation located adjacent to the emission area 62L.

With this configuration, as compared with the case where the emission area 62S for side irradiation is not provided, the emission area of light from the second light source 30S in the projection lens 60 is widened, and the light from the second light source 30S can be emitted from the projection lens 60 to a wider range. Note that light from the second light source 30S may not be emitted from the emission area 62S.

Although the first aspect of the present invention has been described with reference to the first embodiment as an example, the first aspect of the present invention is not limited thereto.

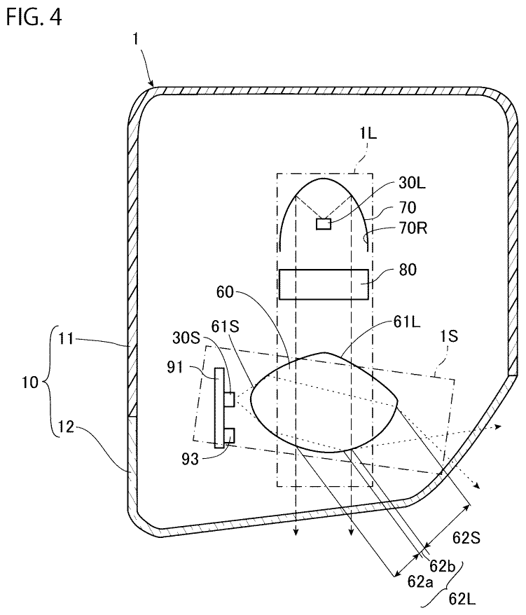

The vehicle headlamp 1 of the present embodiment includes the lamp units 1L and 1H, the second light source 30S, the base plate 91, and the light control circuit 93. However, as illustrated in FIG. 4, the second light source 30S, the light control circuit 93, and the base plate 91 may be combined with the lamp unit 1L. In this case, the projection lens 60 is shared between the lamp unit 1L and the lamp unit 1S, and is a lens common to these units. The projection lens 60 projects light from the first light source 30L forward and projects light from the second light source 30S laterally. In this case, although not illustrated, the lamp unit 1H includes another projection lens different from the projection lens 60 that is shared between the lamp units 1L and 1S. The lamp unit 1H is housed in another housing case 10 different from a certain housing case 10 that houses the lamp units 1L and 1S, and the certain housing case 10 is located on the outer side of a vehicle with respect to the other housing case 10. Note that description is made with reference to the lamp unit 1L, but the second light source 30S, the light control circuit 93, and the base plate 91 may be combined with the lamp unit 1H. The projection lens 60 is shared between the lamp unit 1H and the lamp unit 1S, and is a lens common to these units. In this case, it is sufficient that the housing case 10 housing the lamp units 1H and 1S be located on the outer side of a vehicle with respect to the housing case 10 housing the lamp unit 1L.

In the vehicle headlamp 1 of the present embodiment, a part of the area in the projection lens 60, through which light from the second light source 30S propagates, is used also as the area through which light from the first light source 30L or 30H propagates. In this configuration, at least a part of light from the second light source 30S may not be emitted from the emission area 62L of the projection lens 60, from which light from the first light source 30L is emitted. In addition, both the emission area from which light from the first light source 30L is emitted and the emission area from which light from the second light source 30S is emitted may be spaced apart from each other in the projection lens 60.

In the vehicle headlamp 1 of the present embodiment, at least a part of light from the second light source 30S is emitted from the emission area 62L of the projection lens 60, from which light from the first light source 30L is emitted. In this configuration, a part of the area in the projection lens 60, through which light from the second light source 30S propagates, may not be used also as the area through which light from the first light source 30L or 30H propagates.

The emission area 62L of the present embodiment includes the first area 62a and the second area 62b, but need not be limited thereto. For example, the first area 62a may not be provided, and the emission area 62L may include only the second area 62b. That is, it is sufficient that the emission area 62L include the second area 62b.

The whole incident area 61S of the present embodiment does not overlap the incident areas 61L and 61H, but the present invention need not be limited thereto. For example, at least a part of the incident area 61S may not overlap the incident areas 61L and 61H. Note that the incident area 61S may overlap the incident areas 61L and 61H.

The lamp unit 1L is located further on the outer side of a vehicle with respect to the lamp unit 1H, but may be located further on the inner side of a vehicle with respect to the lamp unit 1H. Compared to the first light sources 30L and 30H of the lamp units 1L and 1H disposed as described above, it is sufficient that light from the second light source 30S be emitted from the emission area from which light from the first light source provided on the outer side of a vehicle among one first light source 30L and the other first light source 30H is emitted. Note that light from the second light source 30S may not be emitted from the emission area from which light from the first light source provided on the outer side of a vehicle among the one first light source 30L and the other first light source 30H is emitted.

The first area 62a may emit light from the second light source 30S, the luminous intensity of which is lower than the luminous intensity of light from the second light source 30S that irradiates the light distribution pattern of light from the second light source 30S, which is emitted from the second area 62b and the emission area 62S. The emission area 62S may emit light from the first light source 30L, the luminous intensity of which is lower than the luminous intensity of light from the first light source 30L that emits the low-beam light distribution pattern.

In the lamp units 1L and 1H, the PES optical system may not be adopted. The arrangement order of the lamp units 1L and 1H in the left-right direction may be reversed. In this case, the projection lens 60 emits light from the second light source 30S laterally not from the emission area 62S but from the emission area 62H.

### Second Embodiment

Next, a second embodiment as a second aspect of the present invention will be described. Note that the same or equivalent components as those of the first embodiment are denoted by the same reference signs, and redundant description is omitted unless otherwise stated.

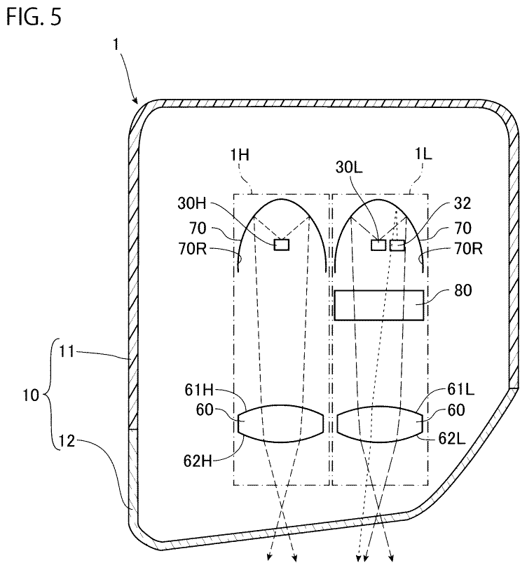

FIG. 5 is a schematic view of a vehicle headlamp according to the present embodiment. A vehicle headlamp 1 is generally provided in each of the left-right directions on the front side of a vehicle, and the left and right vehicle headlamps 1 have a substantially symmetrical configuration in the left-right direction. Therefore, in the present embodiment, the vehicle headlamp 1 on the left side will be described. Note that, in the present specification, “right” means the right side in the forward direction of a vehicle, and “left” means the left side in the forward direction. The vehicle in the present embodiment is an automobile.

The vehicle headlamp 1 includes a housing case 10, a lamp unit 1L for a low-beam light distribution pattern, and a lamp unit 1H for an additional light distribution pattern that is added to the low-beam light distribution pattern to form a high-beam light distribution pattern. In the present embodiment, the lamp unit 1L is located on the outer side of a vehicle with respect to the lamp unit 1H, and is aligned with the lamp unit 1H in the left-right direction. The light distribution pattern means both a shape of an image of light formed on, for example, an imaginary vertical screen 25 m ahead of a vehicle and an intensity distribution of light in the image.

A housing space surrounded by a housing 11 and a front cover 12 is formed in the housing case 10, and the lamp units 1L and 1H are disposed in the housing space. The front cover 12 transmits light emitted from the lamp units 1L and 1H.

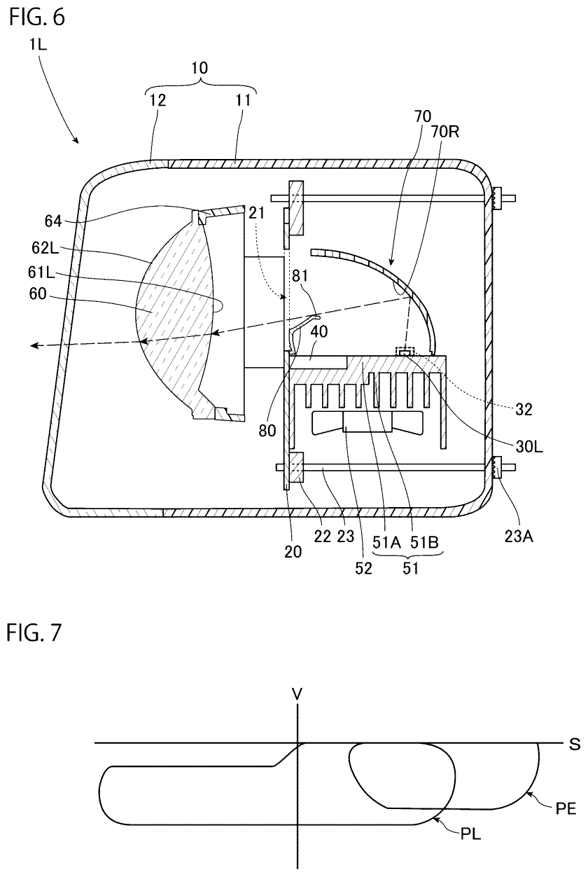

FIG. 6 is a sectional view schematically illustrating the lamp unit 1L. The lamp unit 1L includes a base plate 20, a first light source 30L, a second light source 32, a light control circuit 40, a heat sink 51, a cooling fan 52, a projection lens 60, a reflector 70, and a shade 80.

The base plate 20 includes an opening 21 extending through the base plate 20 in the front-rear direction, and the opening 21 is located on the optical path of light emitted from each of the first light source 30L and the second light source 32.

The first light source 30L in the lamp unit 1L emits first light to be light of a low-beam light distribution pattern. As illustrated in FIG. 5, the second light source 32 is provided adjacent to the first light source 30L in the left-right direction of a vehicle. FIG. 5 illustrates an example in which the second light source 32 is provided on the left side of the first light source 30L. In FIG. 6, the second light source 32 located on the nearer side than the first light source 30L is indicated by a broken line larger than the first light source 30L for the sake of ensuring viewability, but has substantially the same size as the first light source 30L. The second light source 32 emits second light of the enlarged light distribution pattern. The enlarged light distribution pattern is another light distribution pattern projected to the neighborhood of the low-beam light distribution pattern. As described above, since the second light source 32 is provided on the left side of the first light source 30L, the enlarged light distribution pattern is projected on the right side of the low-beam light distribution pattern. Each of the first light source 30L and the second light source 32 includes, for example, a light emitting diode (LED). Switching ON and OFF of the power supply for each of the first light source 30L and the second light source 32, intensity of light from each of the first light source 30L and the second light source 32, and the like are controlled by the light control circuit 40. The light control circuit 40, the first light source 30L, and the second light source 32 are fixed to a base board 51A of the heat sink 51 described later. The emission surface of the second light source 32 is provided at a height position identical to the height position of the emission surface of the first light source 30L in the up-down direction of a vehicle. These emission surfaces are surfaces of the respective light sources opposite to the base board 51A.

In the heat sink 51, the first light source 30L, the second light source 32, and the light control circuit 40 are fixed to one surface side of the base board 51A. In addition, a plurality of heat dissipation fins 51B is integrally provided on a surface of the base board 51A opposite to a side where the first light source 30L, the second light source 32, and the light control circuit 40 are provided. Among the plurality of heat dissipation fins 51B, the heat dissipation fin 51B located at the foremost position is fixed to the back surface of the base plate 20. The heat generated by the first light source 30L, the second light source 32, and the light control circuit 40 is transmitted from the base board 51A to the heat dissipation fin 51B, and the heat dissipation fin 51B is cooled by the airflow caused by the rotation of the cooling fan 52. Therefore, the heat of the first light source 30L, the second light source 32, and the light control circuit 40 is efficiently diffused.

The reflector 70 includes a curved plate material and is fixed to the base board 51A of the heat sink 51 so as to cover the emission surface of each of the first light source 30L and the second light source 32. The surface of the reflector 70 opposing the first light source 30L and the second light source 32 is a concave reflective surface 70R that reflects light from each of the first light source 30L and the second light source 32 without transmitting the light. The reflective surface 70R is based on an ellipsoidal curved surface, and the first light source 30L and the second light source 32 are disposed at or near a position of a first focal point of the ellipsoidal curved surface. At least a part of light emitted from each of the first light source 30L and the second light source 32 is reflected by the reflective surface 70R to the projection lens 60 through the opening 21.

The projection lens 60 is a convex lens, is disposed in front of the base plate 20, and is fixed to the base plate 20 with a lens holder 64 interposed therebetween. The projection lens 60 includes: an incident area 61L on which light from each of the first light source 30L and the second light source 32 is incident; and an emission area 62L from which light from each of the first light source 30L and the second light source 32 incident on the projection lens 60 from the incident area 61L is emitted forward. In the present embodiment, each of the lamp unit 1L and the lamp unit 1H includes the projection lens 60.

The shade 80 is disposed between the reflective surface 70R and the projection lens 60 and is fixed to the base plate 20. An edge portion 81, which is an upper end portion of the shade 80, is located at or near the second focal point of the ellipsoidal curved surface of the reflective surface 70R. The shade 80 is irradiated with a part of light emitted from each of the first light source 30L and the second light source 32 and reflected by the reflector 70. The shade 80 blocks a part of the first light from the first light source 30L such that a light distribution pattern of the first light emitted from the emission area 62L of the projection lens 60 matches a low-beam light distribution pattern. Therefore, a part of the first light is blocked by the shade 80 and is not incident on the projection lens 60. The other part of the first light travels directly from the reflective surface 70R to the incident area 61L of the projection lens 60 without being blocked by the shade 80 and is incident on the incident area 61L, or is reflected by an edge portion 81 of the shade 80 and is incident on the incident area 61L. Accordingly, the first light of a low-beam light distribution pattern reflecting the shape of the cutline by the edge portion 81 of the shade 80 is emitted from the emission area 62L of the projection lens 60 and is projected to the front of a vehicle. The shade 80 blocks a part of the second light from the second light source 32 such that the enlarged light distribution pattern of the second light emitted from the emission area 62L of the projection lens 60 matches an enlarged light distribution pattern. Therefore, a part of the second light is blocked by the shade 80 and is not incident on the projection lens 60. The other part of the second light travels directly from the reflective surface 70R to the incident area 61L of the projection lens 60 without being blocked by the shade 80 and is incident on the incident area 61L, or is reflected by the edge portion 81 of the shade 80 and is incident on the incident area 61L. Accordingly, the second light of the enlarged light distribution pattern from the second light source 32 reflecting the shape of the cutline by the edge portion 81 of the shade 80 is emitted from the emission area 62L of the projection lens 60 and is projected to the front of a vehicle.

A first light source 30H of the lamp unit 1H emits the first light to be light of an additional light distribution pattern that is added to the low-beam light distribution pattern to form the high-beam light distribution pattern. The first light source 30H is disposed at a height position identical to the height position of the first light source 30L and is aligned with the first light source 30L and the second light source 32 in the left-right direction. In the vehicle headlamp 1, the first light source 30H is a light source disposed in another lamp unit different from the lamp unit 1L on which the second light source 32 is mounted.

A surface of the reflector 70 in the lamp unit 1H, opposing the first light source 30H, is the reflective surface 70R that reflects the first light from the first light source 30H without transmitting the light. The reflective surface 70R is based on an ellipsoidal curved surface, and the first light source 30H is disposed at or near a position of a first focal point of the ellipsoidal curved surface. At least a part of the first light emitted from the first light source 30H is reflected by the reflective surface 70R of the lamp unit 1H toward the projection lens 60 through the opening 21.

At least a part of the first light emitted from the first light source 30H is reflected by the reflector 70 and is incident on the incident area 61L of the projection lens 60. Accordingly, the first light of the additional light distribution pattern is emitted from the emission area 62L of the projection lens 60 and is projected to the front of a vehicle.

Next, the operation of the vehicle headlamp 1 of the present embodiment will be described.

In the lamp unit 1L in the state of emitting a low beam, as illustrated in FIGS. 5 and 6, the first light is emitted from the first light source 30L, and this first light is mainly reflected by the reflective surface 70R of the reflector 70. A part of the first light reflected by the reflective surface 70R is blocked by the shade 80, and the other part thereof is incident from the incident area 61L of the projection lens 60 without being blocked by the shade 80 and is emitted from the emission area 62L thereof. Accordingly, as illustrated in FIG. 7, a low-beam light distribution pattern PL, which is a certain light distribution pattern, is projected forward from the vehicle headlamp 1.

In the lamp unit 1L in the state of emitting a low beam, as illustrated in FIG. 5, the second light is emitted from the second light source 32, and this second light is mainly reflected by the reflective surface 70R of the reflector 70. Similarly to the first light from the first light source 30L illustrated in FIG. 6, a part of the second light reflected by the reflective surface 70R is blocked by the shade 80, and the other part thereof is incident from the incident area 61L of the projection lens 60 without being blocked by the shade 80 and is emitted from the emission area 62L thereof. Accordingly, as illustrated in FIG. 7, an enlarged light distribution pattern PE is projected forward from the vehicle headlamp 1. The enlarged light distribution pattern PE is another light distribution pattern different from the low-beam light distribution pattern PL, which is a certain light distribution pattern, and is projected to the neighborhood of, specifically, to the right side of the low-beam light distribution pattern PL. A part of the enlarged light distribution pattern PE overlaps the low-beam light distribution pattern PL, and the other part thereof does not overlap the low-beam light distribution pattern PL. A center of the enlarged light distribution pattern PE overlaps the low-beam light distribution pattern PL but may not overlap the low-beam light distribution pattern PL. Note that, based on the visual sensation of human beings, the enlarged light distribution pattern PE may not overlap the low-beam light distribution pattern PL and may be in contact with the low-beam light distribution pattern PL. In addition, due to the shade 80, the upper edge of the enlarged light distribution pattern PE of the present embodiment is located at a height position identical to the height position of the cutoff line of the low-beam light distribution pattern PL, and the enlarged light distribution pattern PE is prevented from being projected above the cutoff line. In this way, in the state of emitting a low beam, a horizontally long light distribution pattern including the low-beam light distribution pattern PL and the enlarged light distribution pattern PE, which is another light distribution pattern different from the low-beam light distribution pattern PL, is projected to the front of a vehicle. The enlarged light distribution pattern PE ensures the widened light distribution pattern in front of a vehicle, compared to the case where only the low-beam light distribution pattern PL is projected to the front of a vehicle. Accordingly, the traveling road in front of a vehicle is widely irradiated, and visibility is improved.

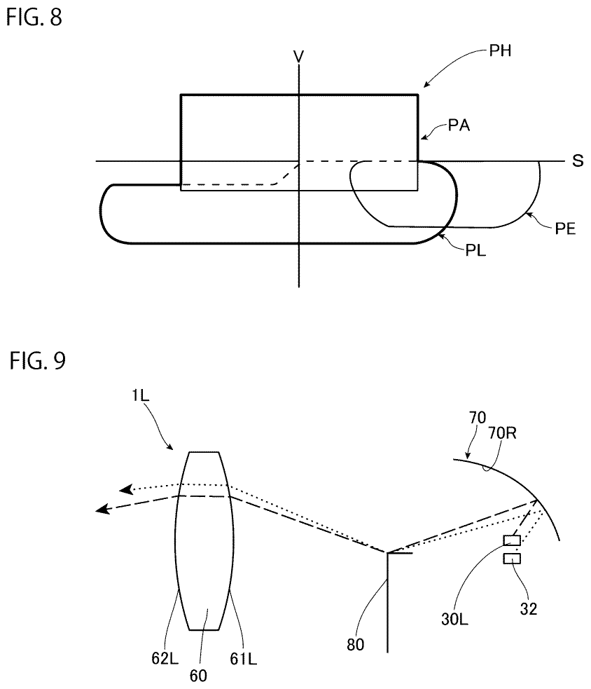

In the lamp unit 1H in the state of emitting a high beam, the low-beam light distribution pattern PL is projected forward from the vehicle headlamp 1 as described above, and the first light is further emitted from the first light source 30H as illustrated in FIGS. 5 and 3. In the lamp unit 1H, the first light is mainly reflected by the reflective surface 70R of the reflector 70. The first light reflected by the reflective surface 70R is incident from the incident area 61H of the projection lens 60 and is emitted from the emission area 62H thereof. Accordingly, as illustrated in FIG. 8, an additional light distribution pattern PA is projected forward from the vehicle headlamp 1 together with the low-beam light distribution pattern PL, and a high-beam light distribution pattern PH indicated by a thick line is formed. The high-beam light distribution pattern PH is formed by adding the additional light distribution pattern PA that is horizontally long and substantially rectangular to the low-beam light distribution pattern PL. A part of the additional light distribution pattern PA overlaps the low-beam light distribution pattern PL, and the additional light distribution pattern PA extends in the horizontal direction and overlaps a horizontal line S. FIG. 8 uses a broken line to denote a portion of the cutoff line, which is the upper edge of the low-beam light distribution pattern PL as well as overlaps the additional light distribution pattern PA. As illustrated in FIG. 8, in a state of emitting a high beam, the enlarged light distribution pattern PE illustrated in FIG. 7 is also projected. In this case, a part of the enlarged light distribution pattern PE overlaps the low-beam light distribution pattern PL and the additional light distribution pattern PA, another part of the enlarged light distribution pattern PE overlaps the low-beam light distribution pattern PL and does not overlap the additional light distribution pattern PA, and still another part of the enlarged light distribution pattern PE does not overlap the low-beam light distribution pattern PL and the additional light distribution pattern PA. Note that, in the state of emitting a high beam, the enlarged light distribution pattern PE illustrated in FIG. 7 is projected, but the enlarged light distribution pattern PE may not be projected.

In the vehicle headlamp of Patent Literature 2, the lamp unit for a low beam and the auxiliary lamp unit are provided separately, and the vehicle headlamp tends to be upsized as a whole. This requires downsizing of a vehicle headlamp that projects, to the front of a vehicle, a horizontally long light distribution pattern including a certain light distribution pattern and another light distribution pattern different from this light distribution pattern.

Given this circumstance, in the vehicle headlamp 1 of the present embodiment, the second light source 32 is mounted at a position covered by the reflector 70 in the lamp unit 1L.

In the vehicle headlamp 1, the first light source 30L and the second light source 32 are mounted on the same PES-type lamp unit 1L and are covered by the reflector 70. Accordingly, as compared with a case where the lamp unit on which the first light source 30L is mounted and the lamp unit on which the second light source 32 is mounted are provided separately, the vehicle headlamp 1 can be downsized while being capable of projecting, to the front of a vehicle, a horizontally long light distribution pattern including the low-beam light distribution pattern PL as a certain light distribution pattern and the enlarged light distribution pattern PE as another light distribution pattern different from the low-beam light distribution pattern PL.

The lamp unit 1L further includes the shade 80 that is provided between the reflector 70 and the projection lens 60 and blocks a part of each of the first light and the second light forming the low-beam light distribution pattern PL reflected by the reflector 70.

In this configuration, the cutoff line of the low-beam light distribution pattern PL is formed by the shade 80. In this configuration, the second light from the second light source 32 is reflected by the reflector 70, a part of the second light reflected by the reflector 70 is blocked by the shade 80, and the other part of the second light is projected to the front of a vehicle by the projection lens 60 without being blocked by the shade 80. With this configuration, the enlarged light distribution pattern PE of the second light is prevented from being projected above the cutoff line of the low-beam light distribution pattern PL. Therefore, a driver of a vehicle can be prevented from having a feeling of strangeness due to the enlarged light distribution pattern PE of the second light being projected above the cutoff line when the low-beam light distribution pattern PL is projected.

The present embodiment has been described with reference to an example in which the second light source 32 is provided to the neighborhood of the first light source 30L in the left-right direction of a vehicle and at a height position identical to the height position of the first light source 30L. However, the position of the second light source 32 is not particularly limited. Hereinafter, modifications of the position of the second light source 32 will be described. In each drawing for explaining the modifications, illustration of components other than the first light source 30L, the second light source 32, the projection lens 60, the shade 80, and the reflector 70 in the lamp unit 1L is omitted.

FIG. 9 is a view illustrating a first modification of the position of the second light source 32. The second light source 32 of the present modification is different from that of the embodiment in that the second light source 32 of the present modification is provided at a position below the first light source 30L in the up-down direction. In this case, for example, a step is provided in the base board 51A, and the surface on which the second light source 32 in the base board 51A is disposed is lower than the surface on which the first light source 30L is disposed. Note that, similarly to the embodiment, the second light source 32 is provided on the left side of the first light source 30L.

In the present modification, similarly to the embodiment, a part of the second light reflected by the reflective surface 70R of the reflector 70 is blocked by the shade 80, and the other part is projected to the front of a vehicle by the projection lens 60 without being blocked by the shade 80. Accordingly, as illustrated in FIGS. 7 and 8, the enlarged light distribution pattern PE is projected forward from the vehicle headlamp 1.

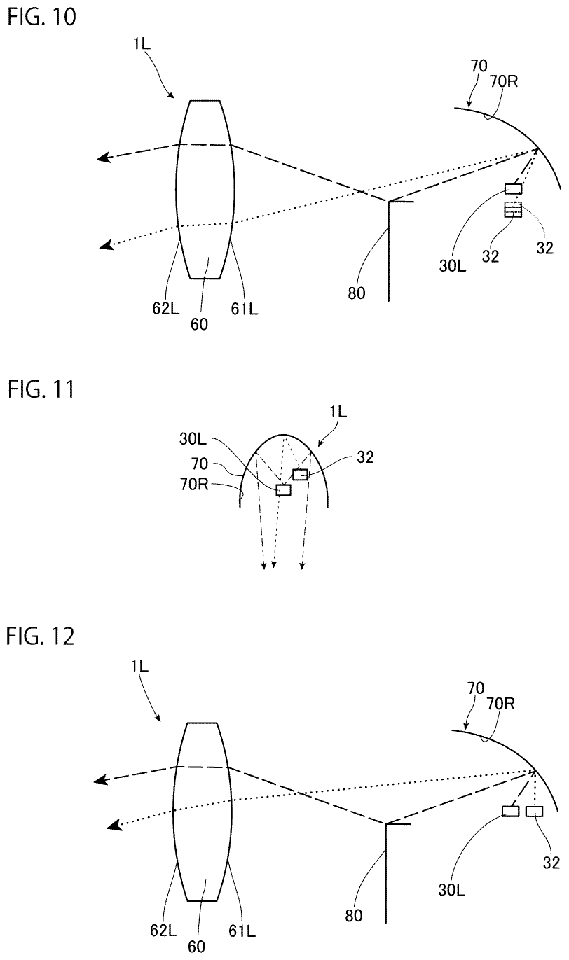

FIG. 10 is a view illustrating a second modification of the position of the second light source 32. The second light source 32 of the present modification is different from that of the embodiment in that the second light source 32 of the present modification is provided at a position below the first light source 30L in the up-down direction. The second light source 32 of the present modification is provided at a position further below the second light source 32 of the first modification. In FIG. 10, the second light source 32 of the first modification illustrated in FIG. 9 is indicated by a dotted line. Note that, similarly to the embodiment, the second light source 32 is provided on the left side of the first light source 30L.

Similarly to the embodiment, in the present modification, the shade 80 blocks a part of the first light forming the low-beam light distribution pattern PL reflected by the reflective surface 70R of the reflector 70. However, unlike the embodiment, the shade 80 in the present modification does not block the second light. The other part of the first light and the second light reflected by the reflective surface 70R of the reflector 70 are projected to the front of a vehicle by the projection lens 60 without being blocked by the shade 80. The second light source 32 of the present modification is provided at a position further below the second light source 32 of the first modification. Accordingly, as illustrated in FIGS. 7 and 8, the enlarged light distribution pattern PE is projected forward from the vehicle headlamp 1.

Also in this configuration, the cutoff line of the low-beam light distribution pattern PL is formed by the shade 80. Furthermore, in this configuration, the second light from the second light source 32 is reflected by the reflector 70, the second light reflected by the reflector 70 is projected to the front of a vehicle by the projection lens 60 without being blocked by the shade 80. With this configuration, as compared with a case where the second light is blocked by the shade 80, the second light is not blocked by the shade 80, and thus the front of a vehicle can be irradiated without waste, and deterioration of the shade 80 due to irradiation of the second light can be prevented.

FIGS. 11 and 12 are views illustrating a third modification of the position of the second light source 32. FIG. 11 is a top view of the first light source 30L and the second light source 32 and the periphery thereof in the present modification. FIG. 12 is a view illustrating a manner of traveling of each of the first light and the second light in the present modification. The second light source 32 of the present modification is different from that of the embodiment in that the second light source 32 of the present modification is provided further on the rear side with respect to the first light source 30L in the front-rear direction of a vehicle. FIG. 11 illustrates an example in which the second light source 32 is provided on the left oblique rear side of the first light source 30L. Note that, similarly to the embodiment, the second light source 32 is provided at a height position identical to the height position of the first light source 30L.

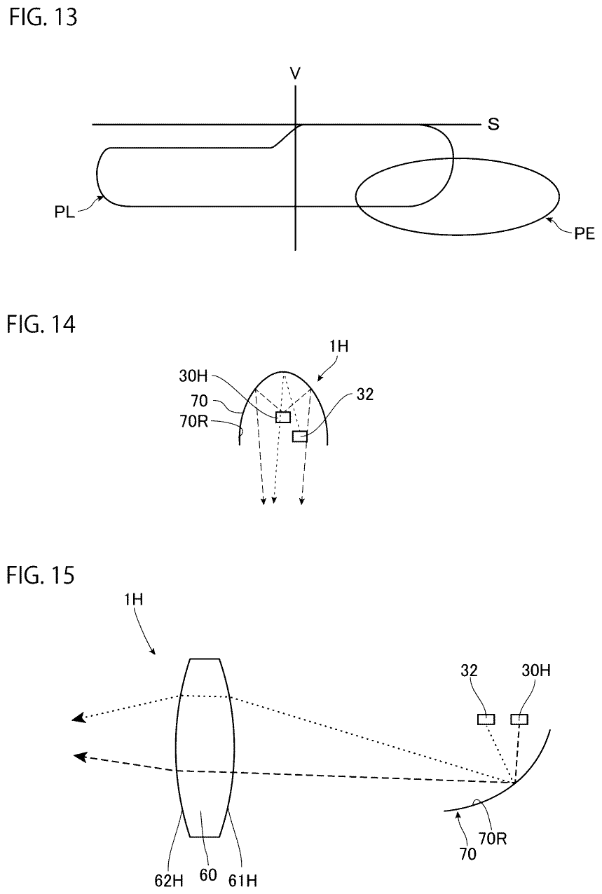

Similarly to the second modification, in the present modification, the second light reflected by the reflective surface 70R of the reflector 70 is projected to the front of a vehicle by the projection lens 60 without being blocked by the shade 80. As illustrated in FIG. 13, the enlarged light distribution pattern PE of the present modification is projected below the cutoff line of the low-beam light distribution pattern PL.

The present embodiment and the above modifications have been described with reference to examples in which the second light source 32 is mounted on the lamp unit 1L for the low-beam light distribution pattern, but the second light source 32 may be mounted on the lamp unit 1H for the additional light distribution pattern PA. FIGS. 14 and 15 are top views illustrating a fourth modification of the position of the second light source 32. FIG. 14 is a top view of the first light source 30H and the second light source 32 and the periphery thereof in the present modification. FIG. 15 is a view illustrating a manner of traveling of each of the first light and the second light in the present modification. In FIG. 15, illustration of components other than the first light source 30H, the second light source 32, and the reflector 70 in the lamp unit 1H is omitted.

In the present modification, the second light source 32 is provided in front of the first light source 30H in the front-rear direction of a vehicle and at a height position identical to the height position of the first light source 30H. FIG. 14 illustrates an example in which the second light source 32 is provided on the left oblique front side of the first light source 30H. The lamp unit 1H of the present modification is vertically reversed as compared with the embodiment. The emission surfaces of the first light source 30H and the second light source 32 face the up direction of a vehicle in the embodiment, but face the down direction in the present modification. The reflector 70 of the present modification is fixed to the base board 51A so as to cover the emission surface of each of the first light source 30L and the second light source 32. Note that, although not illustrated, the second light source 32 is not provided in the lamp unit 1L of the present modification.

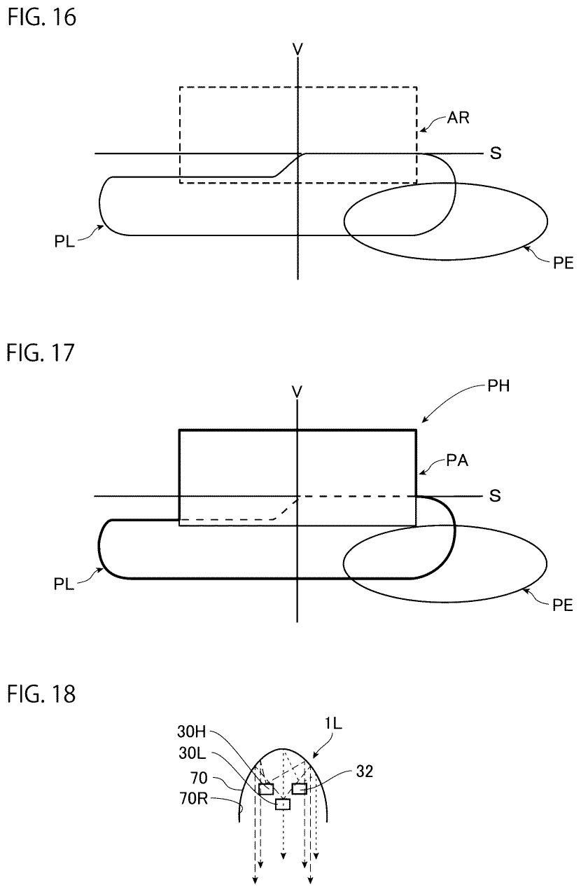

FIG. 16 is a diagram illustrating a light distribution pattern projected to the front of a vehicle when the first light source 30H does not emit the first light and the front of a vehicle is irradiated with the first light of the low-beam light distribution pattern from the lamp unit 1L. The second light source 32 is provided in front of the first light source 30H in the front-rear direction of a vehicle and at a height position identical to the height position of the first light source 30H. Therefore, as illustrated in FIG. 16, the enlarged light distribution pattern PE of the second light from the second light source 32 is projected to the neighborhood of an area AR denoted by the broken line and the low-beam light distribution pattern PL. The area AR is an area indicating the additional light distribution pattern PA based on an assumption that the additional light distribution pattern PA is projected to the front of a vehicle. The enlarged light distribution pattern PE of the present modification is located below the cutoff line of the low-beam light distribution pattern PL and does not overlap the area AR.

FIG. 17 is a diagram illustrating a light distribution pattern projected to the front of a vehicle when the first light source 30H emits the first light and the front of a vehicle is irradiated with the first light of each of the low-beam light distribution pattern and the additional light distribution pattern from the lamp units 1L and 1H. As illustrated in FIG. 17, the enlarged light distribution pattern PE of the second light from the second light source 32 is projected to the neighborhood of the additional light distribution pattern PA and the low-beam light distribution pattern PL. The enlarged light distribution pattern PE of the present modification is located below the cutoff line of the low-beam light distribution pattern PL and does not overlap the additional light distribution pattern PA.

Note that, in the present modification, the position of the second light source 32 is not particularly limited as long as the enlarged light distribution pattern PE is projected to: the neighborhood of the area denoted by the broken line and the low-beam light distribution pattern PL as illustrated in FIG. 16; and the neighborhood of the additional light distribution pattern PA and the low-beam light distribution pattern PL as illustrated in FIG. 17. A part of the enlarged light distribution pattern PE may overlap the additional light distribution pattern PA, or based on the visual sensation of human beings, the enlarged light distribution pattern PE may be in contact with the additional light distribution pattern PA without overlapping the additional light distribution pattern PA.

In the present embodiment, the lamp units 1L and 1H are separated from each other, but the present invention is not limited thereto. FIG. 18 illustrates a fifth modification of the positions of the first light sources 30L and 30H and the second light source 32, and is a top view of the first light source 30L and 30H and the second light source 32 and the periphery thereof in the fifth modification. As illustrated in FIG. 18, in the lamp unit 1L of the present modification, the first light source 30H is further mounted at a position covered by the reflector 70. Accordingly, the lamp unit 1L mounts thereon the first light source 30L that emits the first light to be light of the low-beam light distribution pattern and light of the low-beam light distribution pattern being one of light of the additional light distribution pattern, and the second light source 32 that emits second light. The lamp unit 1L further mounts thereon the first light source 30H that emits the first light to be light of the low-beam light distribution pattern and light of the additional light distribution pattern that is the other of the additional light distribution pattern at a position covered by the reflector 70. Therefore, in the first light sources 30L and 30H and the second light source 32 are mounted at positions covered by the reflector 70 in the same PES-type lamp unit 1L. With this configuration, as compared with a case where the lamp unit on which the first light source 30L is mounted, the lamp unit on which the first light source 30H is mounted, and the lamp unit on which the second light source 32 is mounted are provided separately, the vehicle headlamp 1 can be downsized while being capable of projecting, to the front of a vehicle, a horizontally long light distribution pattern including the low-beam light distribution pattern PL and the other enlarged light distribution pattern PE.

Although the second aspect of the present invention has been described with reference to the second embodiment as an example, the second aspect of the present invention is not limited thereto.

The arrangement order of the lamp units 1L and 1H in the left-right direction may be reversed. The second light source 32 of the vehicle headlamp 1 on the left side emits light of the enlarged light distribution pattern PE to the right side of the low-beam light distribution pattern PL, but may emit light of the enlarged light distribution pattern PE to the left side of the low-beam light distribution pattern PL. The second light source 32 of the vehicle headlamp 1 on the right side emits light of the enlarged light distribution pattern PE to the left side of the low-beam light distribution pattern PL, but may emit light of the enlarged light distribution pattern PE to the right side of the low-beam light distribution pattern PL.

The first aspect of the present invention provides a vehicle headlamp that can be downsized. The second aspect of the present invention provides a vehicle headlamp that can be downsized while being capable of projecting, to the front of a vehicle, a horizontally long light distribution pattern including a certain light distribution pattern and another light distribution pattern different from this light distribution pattern. Both the vehicle headlamps can be used in the field of vehicle headlamps or the like, which is included in automobiles or the like.

1. A vehicle headlamp comprising:
a first light source that emits light to be one of a low beam and a high beam;
a second light source; and
a projection lens that projects the light from the first light source to a front of a vehicle and projects light from the second light source to a lateral side of the vehicle,
wherein, in the projection lens, a part of an area through which the light from the second light source propagates is used also as an area through which the light from the first light source propagates.

2. The vehicle headlamp according to claim 1, wherein
at least a part of the light from the second light source is emitted from an emission area of the projection lens, from which the light from the first light source is emitted.

3. The vehicle headlamp according to claim 2, wherein
the light from the second light source travels directly from an incident area of the projection lens on which the light from the second light source is incident to the emission area.

4. The vehicle headlamp according to claim 2, wherein
the emission area includes
a first area that emits the light from the first light source, and
a second area that is located adjacent to the first area and emits the light from the first light source and the light from the second light source.

5. The vehicle headlamp according to claim 2, wherein
at least a part of an incident area of the projection lens on which the light from the second light source is incident does not overlap an incident area of the projection lens, on which the light from the first light source is incident.

6. The vehicle headlamp according to claim 2, wherein
the first light source comprises two first light sources,
one first light source of the two first light sources emits light of a low beam,
the other first light source of the two first light sources emits light of a high beam, and
the light from the second light source is emitted from the emission area from which the light from the first light source provided on an outer side of the vehicle among the one first light source and the other first light source is emitted.

7. A vehicle headlamp comprising:
a lamp unit of a projector ellipsoid system (PES) type, the lamp unit including
a first light source that emits first light to be one of light of a low-beam light distribution pattern or light of an additional light distribution pattern that is added to the low-beam light distribution pattern to form a high-beam light distribution pattern,
a reflector that covers the first light source and reflects at least a part of the first light from the first light source, and
a projection lens that projects the first light reflected by the reflector to a front of a vehicle; and
a second light source that emits second light of another light distribution pattern reflected by the reflector and projected to a front of the vehicle and to a neighborhood of a light distribution pattern of the first light by the projection lens,
wherein the second light source is mounted at a position covered by the reflector in the lamp unit.

8. The vehicle headlamp according to claim 7, wherein
the lamp unit further includes a shade that is provided between the reflector and the projection lens and blocks a part of each of the first light and the second light forming the low-beam light distribution pattern reflected by the reflector.

9. The vehicle headlamp according to claim 8, wherein
the second light source is provided adjacent to the first light source in a left-right direction of the vehicle and at a height position identical to a height position of the first light source.

10. The vehicle headlamp according to claim 8, wherein
the second light source is provided adjacent to the first light source in a left-right direction of the vehicle and at a position below the first light source.

11. The vehicle headlamp according to claim 7, wherein
the lamp unit further includes a shade that is provided between the reflector and the projection lens and blocks a part of the first light forming the low-beam light distribution pattern reflected by the reflector, and
another part of the first light and the second light that are reflected by the reflector are projected to a front of the vehicle by the projection lens without being blocked by the shade.

12. The vehicle headlamp according to claim 11, wherein
the second light source is provided adjacent to the first light source in a left-right direction of the vehicle and at a position below the first light source.

13. The vehicle headlamp according to claim 11, wherein
the second light source is provided at a position further on a rear side with respect to the first light source.

14. The vehicle headlamp according to claim 7, wherein
the first light is light forming the additional light distribution pattern, and
when the first light source does not emit the first light and a front of the vehicle is irradiated with the first light of the low-beam light distribution pattern, the light distribution pattern of the second light from the second light source is projected to a neighborhood of
an area in front of the vehicle based on an assumption that the additional light distribution pattern is projected to a front of the vehicle, and
the low-beam light distribution pattern.

15. The vehicle headlamp according to claim 7, wherein
the first light is light forming the additional light distribution pattern, and
when the first light source emits the first light and a front of the vehicle is irradiated with the first light of the low-beam light distribution pattern, the light distribution pattern of the second light from the second light source is projected to a neighborhood of the additional light distribution pattern and the low-beam light distribution pattern.

16. The vehicle headlamp according to claim 7, wherein
the lamp unit further includes a first light source that emits first light to be light of the low-beam light distribution pattern and the other of light of the additional light distribution pattern, the first light source being mounted at a position covered by the reflector.
